(19) United States
(12) Patent Application Publication
(10) Pub. No.: US 2021/0371330 A1
(43) Pub. Date: Dec. 2, 2021

(54) ANTIFOULING LAYER-ATTACHED GLASS SUBSTRATE AND METHOD FOR MANUFACTURING ANTIFOULING LAYER-ATTACHED GLASS SUBSTRATE

(71) Applicant: AGC Inc., Tokyo (JP)

(72) Inventors: Akihisa MINOWA, Tokyo (JP); Hitoshi SAIKI, Tokyo (JP); Shunji WACHI, Tokyo (JP); Yusuke ARAI, Tokyo (JP); Takahiro MASHIMO, Tokyo (JP)

(73) Assignee: AGC Inc., Tokyo (JP)

(21) Appl. No.: 17/445,223

(22) Filed: Aug. 17, 2021

Related U.S. Application Data
(63) Continuation of application No. PCT/JP2020/006363, filed on Feb. 18, 2020.

(30) Foreign Application Priority Data
Feb. 22, 2019 (JP) 2019-030975

(51) Int. Cl. C03C 17/32; C03C 3/093; C03C 21/00; C03C 23/00; C03C 17/42

(52) U.S. Cl. CPC C03C 17/32; C03C 3/093; C03C 21/002; C03C 23/0075; C03C 2218/31; C03C 2217/213; C03C 2217/70; C03C 2218/151; C03C 17/42

(57) ABSTRACT

An antifouling layer-attached glass substrate includes a glass substrate having a pair of main surfaces facing each other, and an antifouling layer formed on or above at least one main surface of the glass substrate. At the time of measuring an absorbance inside the antifouling layer-attached glass substrate by a Fourier transform infrared spectrophotometer according to ATR method (Attenuated Total Reflection) from a surface on a side where the antifouling layer is formed, in the case where an absorbance value at 3,955 cm⁻¹ is set to 0.10, a value (H₂O absorbance) obtained by subtracting, as a base, the absorbance value at 3,955 cm⁻¹ from a peak value of an absorbance peak which appears around 3,400 cm⁻¹ is 0.010 or more.

### TECHNICAL FIELD

The present invention relates to an antifouling layer-attached glass substrate and a method for manufacturing an antifouling layer-attached glass substrate.

### BACKGROUND ART

Conventionally, a cover glass has been used as a front plate of a touch panel or display panel used in a display device, etc. of a smartphone, a tablet PC and a car navigation system. Such a touch panel or display panel is touched by a human finger when using it and therefore, fouling such as fingerprint, sebum and sweat is likely to adhere. When these stains are adhered, they are difficult to remove, and a portion to which stains are adhered and a portion to which stains are not adhered are visually distinguished from each other due to a difference in scattering or reflection of light therebetween, giving rise to a problem that the visibility or beauty is impaired. To cope with this problem, there is known a glass substrate where an antifouling layer composed of a fluorine-containing organic compound is formed in a portion that is touched by a human finger, etc. (Patent Literature 1). In order to suppress adhering of stains, the antifouling layer is required to have high water repellency and oil repellency and have abrasion resistance against repeated wiping of stains adhered.

### CITATION LIST

### Patent Literature

Patent Literature 1: JP-A-2000-144097

### SUMMARY OF INVENTION

### Technical Problem

However, in the conventional cover glass, the durability of the antifouling layer is insufficient.

The present invention has been made so as to solve the problem above, and an object thereof is to provide an antifouling layer-attached glass substrate excellent in abrasion resistance of the antifouling layer and a manufacturing method thereof.

### Solution to Problem

The present invention relates to the following antifouling layer-attached glass substrate and a manufacturing method thereof.

An antifouling layer-attached glass substrate including:

a glass substrate having a pair of main surfaces facing each other; and

an antifouling layer formed on at least one main surface of the glass substrate, wherein

at the time of measuring an absorbance inside the antifouling layer-attached glass substrate by a Fourier transform infrared spectrophotometer according to ATR method (Attenuated Total Reflection) from a surface on a side where the antifouling layer is formed, in the case where an absorbance value at 3,955 cm⁻¹ is set to 0.10, the value (H₂O absorbance) obtained by subtracting, as a base, the absorbance value at 3,955 cm⁻¹ from a peak value of an absorbance peak which appears around 3,400 cm⁻¹ is 0.010 or more.

A method for manufacturing an antifouling layer-attached glass substrate, including:

a step of preparing a glass substrate having a pair of main surfaces facing each other;

a step of immersing the glass substrate in a molten salt containing K ion to perform chemical strengthening;

a step of acid-treating the main surfaces of the glass substrate; and

a step of forming an antifouling layer on at least one main surface of the glass substrate,

wherein the molten salt in the chemical strengthening step further contains 10 ppm or more of Li ion or 100 ppm or more of NO²⁻ ion or contains Li ion and NO²⁻ ion, with a Li ion content being 10 ppm or more or a NO²⁻ ion content being 100 ppm or more.

### Advantageous Effects of Invention

According to the present invention, an antifouling layer-attached glass substrate excellent in abrasion resistance of the antifouling layer can be provided.

### BRIEF DESCRIPTION OF DRAWINGS

FIG. 1 is a schematic cross-sectional view in Embodiment 1 of the antifouling layer-attached glass substrate of the present invention.

FIG. 2 is a schematic cross-sectional view in Embodiment 2 of the antifouling layer-attached glass substrate of the present invention.

FIG. 3 is a schematic cross-sectional view in Modification Example of the antifouling layer-attached glass substrate of the present invention.

FIG. 4 is a manufacturing flow in Embodiment 1 of the manufacturing method of an antifouling layer-attached glass substrate of the present invention.

FIG. 5 is a manufacturing flow in Embodiment 2 of the manufacturing method of an antifouling layer-attached glass substrate of the present invention.

### DESCRIPTION OF EMBODIMENTS

The antifouling layer-attached glass substrate of the present invention is characterized in that in a method of measuring the absorbance inside the antifouling layer-attached glass substrate by a Fourier transform infrared spectrometer (hereinafter, referred to as FTIR), in the case where the surface on the side where the antifouling layer of the antifouling layer-attached glass substrate is formed is measured according to ATR method (Attenuated Total Reflection) and the absorbance value at 3,955 cm⁻¹ is set to 0.10, the value (H₂O absorbance) obtained by subtracting, as a base, the absorbance value at 3,955 cm⁻¹ from the peak value of the observed absorbance peak present around 3,400 cm⁻¹ is 0.010 or more.

The infrared spectroscopy (abbreviation: IR method) is a measuring method used for determining the properties of an object, and in the present invention, the measurement is performed using, among those, a Fourier transform infrared spectroscopy (abbreviation: FTIR). Among measuring methods using FTIR, the measurement is performed by a contact method called ATR method (Attenuated Total Reflection). The ATR method is a reflection measuring method utilizing a phenomenon that when a sample is contacted with a prism and infrared light is input from the prism side, light penetration into the sample side occurs at the time of total reflection of the infrared light inside the prism. According to the ATR method, an FTIR spectrum from the sample surface to several μm can be acquired.

In the measurement using FTIR, an absorbance peak attributable to H₂O appears around a wavelength of 3,400 cm⁻¹, and an absorbance peak attributable to Si—OH appears around a wavelength of 3,600 cm⁻¹.

Here, the absorbance is a value represented by the following formula using the ratio between the incident light intensity To and the transmitted light intensity I, i.e., taking a common logarithm of the transmittance.

−log₁₀(I/I₀)

In the present invention, the measurement is performed by bringing a prism into contact with the outermost surface of the antifouling layer-attached glass substrate on the side where the antifouling layer is formed. Since each of the thickness of the antifouling layer and in the case of forming an adhesive layer and an antireflection layer, the thicknesses thereof is from several tens of nm to several hundreds of nm, the total H₂O amount and total Si—OH amount in all layers from the antifouling layer to the glass substrate can be known by this measurement.

Accordingly, in the present invention, as the indexes of H₂O amount and Si—OH amount of the antifouling layer-attached glass substrate, the values obtained by subtracting, as a base, the absorbance value at 3,955 cm⁻¹ from the absorbance peak attributable to H₂O present around a wavelength of 3,400 cm⁻¹ and from the absorbance peak attributable to Si—OH present around a wavelength of 3,600 cm⁻¹, respectively, are used. In order to reduce a variation in the measurement, the absorbance at each wavelength is measured under the measurement conditions where the absorbance at a wavelength of 3,955 cm⁻¹ becomes 0.10. Hereinafter, the value obtained by subtracting, as a base, the absorbance at a wavelength of 3,955 cm⁻¹ from the peak value of the absorbance peak present around a wavelength of 3,400 cm⁻¹ is referred to as “H₂O absorbance”, and the value obtained by subtracting, as a base, the absorbance at a wavelength of 3,955 cm⁻¹ from the peak value of the absorbance peak present around a wavelength of 3,600 cm⁻¹ is referred to as “Si—OH absorbance”.

The antifouling layer-attached glass substrate of the present invention is characterized in that the H₂O absorbance is 0.010 or more. More specifically, this means that the H₂O content in a region from the surface to a depth of several μm of the antifouling layer-attached glass substrate is not less than a given amount. As a result of intensive studies, it has been found that when the antifouling layer-attached glass substrate has such a configuration, the abrasion resistance of the antifouling layer is improved. The present invention is based on this finding.

In the antifouling layer-attached glass substrate of the present invention, the H₂O absorbance is 0.010 or more, preferably 0.014 or more, more preferably 0.018 or more, still more preferably 0.020 or more. When the H₂O absorbance is in this range, the H₂O content of the antifouling layer-attached glass substrate is increased and the abrasion resistance of the antifouling layer can be improved. On the other hand, the H₂O absorbance is generally 0.1 or less.

The reason why the abrasion resistance of the antifouling layer is improved by increasing the H₂O content in the antifouling layer-attached glass substrate is considered as follows.

The antifouling layer usually contains an organosilicon compound, and a Si—X structure (examples of X include a hydrolyzable group such as alkoxy group, acyloxy group, ketooxime group, alkenyloxy group, amino group, aminoxy group, amide group, isocyanate group and halogen atom) is present in the antifouling layer surface. At the time of forming the antifouling layer on a surface of the glass substrate or adhesive layer, Si—X produces silanol (Si—OH) as a result of hydrolysis, and the silanol reacts with Si—OH present in a surface of the glass substrate or adhesive layer formed on the glass substrate and forms a Si—O—Si bond, whereby the adhesiveness between the antifouling layer and a surface in contact with the antifouling layer is enhanced.

Then, as the means for improving the abrasion resistance of the antifouling layer, it is conceived to previously increase Si—OH in a surface of the glass substrate or adhesive layer before forming the antifouling layer.

However, because of a problem of energy balance, the glass substrate or adhesive layer before the formation of the antifouling layer is bound by an upper limit of the area density of Si—OH that can be increased in a surface of the glass substrate or adhesive layer. Accordingly, a surface of such a layer is in a state of Si—OH and Si—Y (Y is a group that can be taken due to the composition, except for OH group) being mixed.

Therefore, it is thought that at the time of forming the antifouling layer while increasing the H₂O content in the entire antifouling layer-attached glass substrate, when the OH group of Si—OH in a surface of the glass substrate or adhesive layer is consumed in the reaction bonding with silanol in the antifouling layer, an exchange reaction of Y and H₂O occurs in Si—Y present in the vicinity, and Si—Y changes into Si—OH. New Si—OH generated due to this phenomenon reacts with silanol in the antifouling layer, as a result, a Si—O—Si bond can be newly formed.

Consequently, it is believed that when the H₂O content in the entire antifouling layer-attached glass substrate is increased, the adhesiveness between the antifouling layer and the glass substrate or between the antifouling layer and the adhesive layer surface can be increased and the abrasion resistance can thereby be improved.

The principle of enhancing the abrasion resistance in the antifouling layer-attached glass substrate of the present invention is not limited thereto.

On the other hand, in the antifouling layer-attached glass substrate of the present invention, the Si—OH absorbance is preferably 0.0070 or more, more preferably 0.0080 or more, still more preferably 0.0090 or more. When the Si—OH absorbance is in this range, the electric charge amount of the antifouling layer-attached glass substrate is reduced, and the adhesion between the antifouling layer and the glass substrate is enhanced.

In the present invention, the method for manufacturing an antifouling layer-attached glass substrate with a high H₂O content includes, for example, the following two methods.

First, there is a manufacturing method where an adhesive layer is formed between the glass substrate and the antifouling layer. The composition of the adhesive layer is not particularly limited but, for example, a component mainly consisting of silicon dioxide is used.

In the antifouling layer-attached glass substrate of the present invention, when the adhesive layer is analyzed, it has been found that the packing density in the upper portion of the adhesive layer is low to make the adhesive layer sparse. Accordingly, it is considered that when a larger amount of voids than usual are present in the upper portion of the adhesive layer and H₂O is caused to adsorb to the voids, the H₂O content in the antifouling layer-attached glass substrate can be increased.

Second, there is a manufacturing method where the glass substrate is immersed in a molten salt mainly containing K ion and containing one or two ions selected from Li ion and NO²⁻ ion to effect an ion exchange treatment and then acid-treated. The manufacturing method of an antifouling layer-attached glass substrate of the present invention is characterized in that the molten salt mainly containing K ion contains 10 ppm or more of Li ion or 100 ppm or more of NO²⁻ ion or contains both Li ion and NO²⁻ ion, with the Li ion content being 10 ppm or more or the NO²⁻ ion content being 100 ppm or more. By adopting such a configuration, the H₂O content of the antifouling layer-attached glass substrate can be increased without providing an adhesive layer.

The configuration above makes it possible to increase the H₂O content in the antifouling layer-attached glass substrate, adjust the H₂O absorbance to 0.010 or more and, in turn, improve the abrasion resistance of the antifouling layer. The method for adjusting the H₂O absorbance to 0.010 or more is not limited thereto, and the absorbance in this range can be realized by other methods.

The embodiments of the present invention are described in detail below by referring to the drawings.

### Embodiment 1 of Antifouling Layer-Attached Glass Substrate

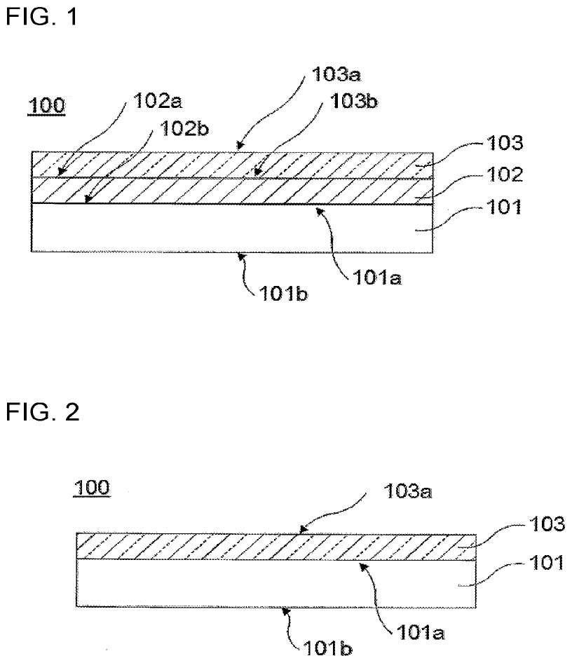

FIG. 1 is a schematic view of the antifouling layer-attached glass substrate in Embodiment 1 of the present invention. As illustrated in FIG. 1, the antifouling layer-attached glass substrate 100 in Embodiment 1 has a glass substrate 101, an adhesive layer 102, and an antifouling layer 103.

The glass substrate 101 has a first main surface 101a and a second main surface 101b facing each other. On the first main surface 101a, an adhesive layer 102 is formed. The adhesive layer 102 has a first surface 102a farther from the glass substrate 101 and a second surface 102b closer to the glass substrate 101. On the first surface 102a of the adhesive layer, an antifouling layer 103 is formed. The antifouling layer 103 has a first surface 103a farther from the substrate 101 and a second surface 103b closer to the glass substrate 101. The adhesive layer 102 and the antifouling layer 103 may be formed on the second main surface 101b side or may be formed on both surfaces (first main surface 101a, second main surface 101b) of the glass substrate.

In the following, each configuration of the antifouling layer-attached glass substrate 100 is described in detail.

### (Glass Substrate)

The glass substrate 101 used in this embodiment is not particularly limited, and a common glass containing silicon dioxide as a main component, for example, a glass substrate such as soda lime silicate glass, aluminosilicate glass, borosilicate glass, alkali-free glass or silica glass, may be used.

The antifouling layer-attached glass substrate 100 of the present invention is utilized as a cover glass on a touch panel or display panel used in a display device, etc. of a smartphone, a tablet PC and a car navigation system. In this case, the glass substrate 101 is preferably subjected to a strengthening treatment. The strengthening treatment is physical strengthening or chemical strengthening, and among others, a chemical strengthening treatment is preferably applied.

The composition of the glass substrate 101 used in this embodiment is therefore preferably a composition capable of being strengthened by a chemical strengthening treatment and preferably contains, for example, an alkali metal having a small ionic radius, such as sodium and lithium. Such a glass includes, for example, an aluminosilicate glass, a soda lime silicate glass, a borosilicate glass, a lead glass, an alkali barium glass, and an aluminoborosilicate glass.

In the present description, the glass after being subjected to chemical strengthening is referred to as “chemically strengthened glass”. The base composition of the chemically strengthened glass is the same as that of the glass before chemical strengthening, and the base composition of the chemically strengthened glass is the composition inside of the glass excluding a layer where ion exchange in a glass surface has been effected.

As a specific glass composition (i.e., a base composition in the chemically strengthened glass), for example, the following composition facilitates the formation of a preferable stress profile by a chemical strengthening treatment.

(1) The glass composition preferably contains, as represented by mass percentage based on oxides, from 50 to 80% of SiO₂, from 10 to 25% of Al₂O₃, from 0 to 10% of B₂O₃, from 2 to 10% of Li₂O, from 0 to 11% of Na₂O, and from 0 to 10% of K₂O, with the total MgO+CaO+SrO+BaO of the contents of MgO, CaO, SrO and BaO being from 0 to 10% and the total ZrO₂+TiO₂ of the contents of ZrO₂ and TiO₂ being from 0 to 5%.

(2) The glass composition more preferably contains, as represented by mass percentage based on oxides, from 55 to 80% of SiO₂, from 10 to 28% of Al₂O₃, from 0 to 10% of B₂O₃, from 2 to 10% of Li₂O, from 0.5 to 11% of Na₂O, and from 0 to 10% of K₂O, with the total (MgO+CaO+SrO+BaO) of the contents of MgO, CaO, SrO and BaO being from 0 to 10% and the total (ZrO₂+TiO₂) of the contents of ZrO₂ and TiO₂ being from 0 to 5%.

(3) The glass composition still more preferably contains, as represented by mass percentage based on oxides, from 55 to 75% of SiO₂, from 10 to 25% of Al₂O₃, from 0 to 10% of B₂O₃, from 2 to 10% of Li₂O, from 1 to 11% of Na₂O, and from 0.5 to 10% of K₂O, with (MgO+CaO+SrO+BaO) being from 0 to 10% and (ZrO₂+TiO₂) being from 0 to 5%.

Each component of the glass composition is described in detail below. In the following, unless otherwise indicated, the % notation means a mass percentage.

SiO₂ is a component constituting the glass matrix. This is a component enhancing the chemical durability and is a component reducing the generation of cracks when the glass surface is damaged. The content of SiO₂ is preferably 50% or more, more preferably 55% or more, still more preferably 58% or more.

In order to increase the meltability of the glass, the content of SiO₂ is preferably 80% or less, more preferably 75% or less, still more preferably 70% or less.

Al₂O₃ is an effective component for enhancing the ion exchangeability during chemical strengthening and increasing the surface compressive stress after strengthening and is also a component contributing to achieving a high glass transition temperature (Tg) and a high Young's modulus. The content thereof is preferably 10% or more, more preferably 13% or more, still more preferably 15% or more.

In order to increase the meltability, the content of Al₂O₃ is preferably 28% or less, more preferably 26% or less, still more preferably 25% or less.

B₂O₃ is not essential but may be added so as to, for example, enhance the meltability at the time of glass production. In the case of containing B₂O₃, the content thereof is preferably 0.5% or more, more preferably 1% or more, still more preferably 2% or more.

The content of B₂O₃ is preferably 10% or less, more preferably 8% or less, still more preferably 5% or less, yet still more preferably 3% or less, and most preferably 1% or less. Within this range, the occurrence of striae during melting and in turn, reduction in the quality of the glass for chemical strengthening can be prevented. In order to increase the acid resistance, it is preferable to be substantially free of B₂O₃.

Li₂O is a component forming a surface compressive stress by ion exchange. In order to increase the depth of compressive stress layer DOL, the content of Li₂O is preferably 2% or more, more preferably 3% or more, still more preferably 4% or more.

In order to increase the chemical durability of the glass, the content of Li₂O is preferably 10% or less, more preferably 8% or less, still more preferably 7% or less. In one embodiment of the manufacturing method of the present invention, the H₂O absorbance is increased by performing an acid treatment. When the Li₂O content is in the range above, good chemical durability is attained, and this makes it possible to perform the acid treatment.

Na₂O is not essential, but Na₂O is a component forming a surface compressive stress layer by ion exchange utilizing a molten salt containing potassium and is also a component enhancing the meltability of the glass. The content of Na₂O is preferably 0.5% or more, more preferably 1% or more, still more preferably 1.5% or more.

In addition, the content of Na₂O is preferably 11% or less, more preferably 10% or less, still more preferably 8% or less, yet still more preferably 6% or less.

K₂O is not essential but may be contained so as to enhance the meltability of the glass and prevent devitrification. The content of K₂O is preferably 0.5% or more, more preferably 1% or more.

Also, in order to increase the compressive stress value by ion exchange, the content of K₂O is preferably 10% or less, more preferably 9% or less, still more preferably 8% or less.

Alkali metal oxides such as Li₂O, Na₂O and K₂O are all a component lowering the melting temperature of the glass, and the total (Li₂O+Na₂O+K₂O) of the contents of Li₂O, Na₂O and K₂O is preferably 2% or more, more preferably 5% or more, still more preferably 7% or more, yet still more preferably 8% or more.

In order to maintain the strength of the glass, (Li₂O+Na₂O+K₂O) is preferably 20% or less, more preferably 18% or less.

Alkaline earth metal oxides such as MgO, CaO, SrO and BaO are all a component enhancing the meltability of the glass but tend to decrease the ion exchange performance.

For this reason, the total (MgO+CaO+SrO+BaO) of the contents of MgO, CaO, SrO and BaO is preferably 10% or less, more preferably 5% or less.

In the case of containing any of MgO, CaO, SrO and BaO, in order to increase the strength of the chemically strengthened glass, it is preferable to contain MgO.

In the case of containing MgO, the content thereof is preferably 0.1% or more, more preferably 0.5% or more.

In order to enhance the ion exchange performance, the content is preferably 10% or less, more preferably 5% or less.

In the case of containing CaO, the content thereof is preferably 0.5% or more, more preferably 1% or more. In order to enhance the ion exchange performance, the content is preferably 5% or less, more preferably 1% or less, and it is still more preferable to be substantially free of this component.

In the case of containing SrO, the content thereof is preferably 0.5% or more, more preferably 1% or more. In order to enhance the ion exchange performance, the content is preferably 5% or less, more preferably 1% or less, and it is still more preferable to be substantially free of this component.

In the case of containing BaO, the content thereof is preferably 0.5% or more, more preferably 1% or more. In order to enhance the ion exchange performance, the content is preferably 5% or less, more preferably 1% or less, and it is still more preferable to be substantially free of this component.

ZnO is a component enhancing the meltability of the glass and may be contained. In the case of containing ZnO, the content thereof is preferably 0.2% or more, more preferably 0.5% or more. In order to increase the weather resistance of the glass, the content of ZnO is preferably 5% or less, more preferably 1% or less, and it is still more preferable to be substantially free of this component.

TiO₂ is a component improving the crushability of the chemically strengthened glass and may be contained. In the case of containing TiO₂, the content thereof is preferably 0.10% or more. In order to prevent devitrification during melting, the content of TiO₂ is preferably 5% or less, more preferably 1% or less, and it is still more preferable to be substantially free of this component.

ZrO₂ is a component increasing the surface compressive stress by ion exchange and may be contained. In the case of containing ZrO₂, the content thereof is preferably 0.5% or more, more preferably 1% or more. In order to prevent devitrification during melting, the content is preferably 5% or less, more preferably 3% or less.

The content (TiO₂+ZrO₂) of TiO₂ and ZrO₂ is preferably 5% or less, more preferably 3% or less.

Y₂O₃, La₂O₃ and Nb₂O₅ are a component improving the crushability of the chemically strengthened glass and may be contained. In the case of containing these components, the content of each is preferably 0.5% or more, more preferably 1% or more, still more preferably 1.5% or more, yet still more preferably 2% or more, and most preferably 2.5% or more.

The total of the contents of Y₂O₃, La₂O₃ and Nb₂O₅ is preferably 9% or less, more preferably 8% or less. Within this range, the glass is resistant to devitrification during melting, and a reduction in the quality of the chemically strengthened glass can be prevented. Also, each of the contents of Y₂O₃, La₂O₃ and Nb₂O₅ is preferably 3% or less, more preferably 2% or less, still more preferably 1% or less, yet still more preferably 0.7% or less, and most preferably 0.3% or less.

Ta₂O₅ and Gd₂O₃ may be contained each in a small amount in order to improve the crushability of the chemically strengthened glass, but since the refractive index or reflectance rises, each of the contents thereof is preferably 1% or less, more preferably 0.5% or less, and it is still more preferable to be substantially free of these components.

P₂O₅ may be contained in order to enhance the ion exchange performance. In the case of containing P₂O₅, the content thereof is preferably 0.5% or more, more preferably 1% or more. In order to increase the chemical durability, the content of P₂O₅ is preferably 2% or less, and it is more preferably to be substantially free of this component.

In the case of coloring the glass before use, a coloring component may be added to the extent not impeding the attainment of desired chemical strengthening characteristics. Suitable coloring components include, for example, Co₃O₄, MnO₂, Fe₂O₃, NiO, CuO, Cr₂O₃, V₂O₅, Bi₂O₃, SeO₂, TiO₂, CeO₂, Er₂O₃, and Nd₂O₃. One of these may be used alone, or some of them may be used in combination.

The total content of the coloring components is preferably 7% or less. Within this range, the devitrification of the glass can be prevented. The content of the coloring components is more preferably 5% or less, still more preferably 3% or less, yet still more preferably 1% or less. In the case of intending to increase the visible light transmittance of the glass, it is preferable to be substantially free of these components.

SO₃, chlorides, fluorides, etc. may be appropriately contained as a refining agent at the time of melting of the glass. Preferably, As₂O₃ is substantially not contained. In the case of containing Sb₂O₃, the content thereof is preferably 0.3% or less, more preferably 0.1% or less, and it is most preferable to be substantially free of this component.

The properties of the glass substrate 101 are described below.

The shape of the glass substrate 101 is not limited only to a flat shape illustrated in FIG. 1 but may also be a curved shape having one or more bent portions. In addition, the shape in front view includes, for example, a rectangle, a trapezoid, a circle, an ellipse, etc.

The thickness of the glass substrate 101 is not particularly limited. For example, in the case of a cover glass for mobile devices, the thickness is preferably from 0.1 mm to 2.5 mm, more preferably from 0.2 mm to 1.5 mm, still more preferably from 0.5 mm to 1 mm. For example, in the case of an image display device such as display device, car navigation, console panel, instrument panel, etc., the thickness of the glass substrate 101 is preferably from 0.1 mm to 2.1 mm. In the case where a plurality of glasses are stuck together by a laminate material, an adhesive material and other methods, the glass thickness here indicates the thickness of single glass before bonding.

### (Adhesive Layer)

The adhesive layer 102 is formed at least on a first main surface 101a of the glass substrate 101. The composition of the adhesive layer 102 is not particularly limited but includes, for example, silicon dioxide, alumina, etc. Preferably, the adhesive layer is formed from a composition mainly consisting of silicon dioxide.

It is preferred that the packing density is lower in a part of the adhesive layer 102, compared with other portions of the adhesive layer 102. In a portion where the packing density is low, many voids are present in the crystal structure and since H₂O is adsorbed in the voids, the H₂O content in the entire glass substrate 101 can be increased. In particular, the adhesive layer 102 is preferably separated into two layers having different densities. The method for decreasing the packing density in part of the adhesive layer 102 includes, for example, a method of forming the adhesive layer by a vacuum deposition method, etc. described later in Embodiment 1 of Manufacturing Method.

In the case where the adhesive layer 102 is separated into two layers, the density of a layer farther from the glass substrate 101 is preferably lower than the density of a layer closer to the glass substrate 101. At this time, when the adhesive layer 102 is formed of silicon dioxide, the film density of a layer closer to the glass substrate 101 is preferably 2.25 g/cm³ or less, more preferably 2.00 g/cm³ or less. On the other hand, when the film density is 1.75 g/cm³ or more, the strength of the adhesive layer 102 is advantageously ensured. The film density of a layer farther from the glass substrate 101 is preferably 2.00 g/cm³ or less, more preferably 1.85 g/cm³ or less, and in this case, it is likely that the crystal structure mainly consisting of silicon dioxide contains many voids and H₂O is adsorbed in the voids.

In addition, the thickness of a layer closer to the glass substrate 101 is preferably 19 nm or more, more preferably 48 nm or more, and in this case, the strength of the adhesive layer is likely to be ensured. The thickness of a layer farther from the glass substrate 101 is preferably 1.0 nm or more, more preferably 2.0 nm or more, and this makes it possible to sufficiently ensure a crystal structure having voids and increase the amount of H₂O adsorbed.

As the method for knowing the film density or two-layer separation of the adhesive layer 102, for example, an X-ray reflection method (X-Ray Reflectometry, abbreviation: XRR) may be used. The method by XRR enables knowing the film density or a point where the density changes within the film. The point where the density changes within the film indicates a value calculated, assuming the adhesive layer 102 is a model of a plurality of layers having different densities, at the time of performing computational fitting from the XRR spectrum by using the film thickness, film density and surface roughness as parameters.

The thickness of the adhesive layer 102 is preferably 20 nm or more, more preferably 30 nm or more, still more preferably 50 nm or more. When the thickness of the adhesive layer is in this range, a low-density region is likely to be formed in a region closer to the first main surface 102a of the adhesive layer 102, and water tends to be adsorbed in voids of the structure. On the other hand, the thickness of the adhesive layer is preferably 100 nm or less, more preferably 80 nm or less, and this is advantageous in that the packing density in the adhesive layer surface is not excessively reduced and the rubbing resistance of the film can be prevented from decreasing.

### (Antifouling Layer)

The antifouling layer 103 contains a fluorine-containing organic compound. The fluorine-containing organic compound is not particularly limited as long as it has any one or more characteristics of antifouling property, water repellency, oil repellency, hydrophilicity and lipophilicity. The antifouling layer 103 can have a function of, for example, suppressing the attachment of not only a fingerprint mark but also a variety of contaminants such as sweat or dust, facilitating the wiping off of contaminants, or making the contaminants visually inconspicuous.

The fluorine-containing organic compound includes, for example, a perfluoroalkyl group-containing compound, a perfluoropolyether group-containing compound, etc., and a silane compound having a perfluoropolyether group is preferably used.

The silane compound having a perfluoropolyether group includes, for example, a material containing a compound represented by the following formula A and/or a partially hydrolyzed condensate thereof.

Rf³—Rf²—Z¹ formula A

In the formula A, Rf³ is a group: CₘF₂ₘ₊₁ (wherein m is an integer of 1 to 6),

Rf² is a group: —O—(CₐF₂ₐO)ₙ— (wherein a is an integer of 1 to 6, n is an integer of 1 or more, and when n is 2 or more, respective —CₐF₂ₐO— units may be identical to or different from each other), and

Z¹ is a group: -Q²-{CH₂CH(SiR²_{q}X²_{3-q})}ᵣ—H (wherein Q² is —(CH₂)ₛ— (wherein s is an integer of 0 to 12) or —(CH₂)ₛ— containing one or more selected from an ester bond, an ether bond, an amide bond, a urethane bond, and a phenylene group, part or all of —CH₂— units may be replaced by —CF₂— unit and/or —CF(CF₃)— unit, R² is a hydrogen atom or a monovalent hydrocarbon group having a carbon atom number of 1 to 6, the hydrocarbon group may have a substituent, each X² is independently a hydroxyl group or a hydrolyzable group, q is an integer of 0 to 2, and r is an integer of 1 to 20).

The hydrolyzable group in X² includes, for example, an alkoxy group, an acyloxy group, a ketoxime group, an alkenyloxy group, an amino group, an aminoxy group, an amide group, an isocyanate group, a halogen atom, etc. Among these, in view of the balance between stability and ease of hydrolysis, an alkoxy group, an isocyanate group and a halogen atom (particularly, chlorine atom) are preferred. As the alkoxy group, an alkoxy group having a carbon number of 1 to 3 is preferred, and a methoxy group or an ethoxy group is more preferred.

As the material that can form the antifouling layer 103, for example, commercially available “Afluid (registered trademark)S-550” (trade name, manufactured by AGC Inc.), “KP-801” (trade name, manufactured by Shin-Etsu Chemical Co., Ltd.), “X-71” (trade name, manufactured by Shin-Etsu Chemical Co., Ltd.), “KY-130” (trade name, manufactured by Shin-Etsu Chemical Co., Ltd.), “KY-178” (trade name, manufactured by Shin-Etsu Chemical Co., Ltd.), “KY-185” (trade name, manufactured by Shin-Etsu Chemical Co., Ltd.), “KY-195” (trade name, manufactured by Shin-Etsu Chemical Co., Ltd.), “OPTOOL (registered trademark) DSX (trade name, manufactured by Daikin Industries, Ltd.)”, etc. can be used. Furthermore, a material prepared by adding an oil or adding an antistatic agent etc. to the commercially available product may also be used.

The thickness of the antifouling layer 103 is not particularly limited but is preferably 8 nm or more, more preferably 10 nm or more, still more preferably 12 nm or more. On the other hand, the thickness of the antifouling layer 103 is preferably 30 nm or less, more preferably 20 nm or less, still more preferably 19 nm or less. When the thickness of the antifouling layer 103 is 8 nm or more, a layer in contact with the second surface 103b of the antifouling layer 103 can be uniformly covered, and the abrasion resistance is enhanced. When the thickness of the antifouling layer 103 is 30 nm or less, optical properties such as luminous reflectance and haze value in the state of the antifouling layer 103 being stacked are improved.

### Embodiment 2 of Antifouling Layer-Attached Glass Substrate

FIG. 2 is a schematic view of the antifouling layer-attached glass substrate in Embodiment 2 of the present invention. As illustrated in FIG. 2, the antifouling layer-attached glass substrate 100 in Embodiment 2 has a glass substrate 101 and an antifouling layer 103.

The glass substrate 101 has a first main surface 101a and a second main surface 101b facing each other. On the first main surface 101a, an antifouling layer 103 is formed. The antifouling layer 103 has a first surface 103a farther from the glass substrate 101 and a second surface 103b closer to the glass substrate 101. The antifouling layer 103 may be formed on the second main surface 101b or may be formed on both the first main surface 101a and the second main surface 101b.

In order to realize Embodiment 2 of the antifouling layer-attached glass substrate of the present invention, there may be conceived an idea of, for example, controlling the type or particle size of the glass raw material used, controlling the water content or oxygen content in the atmosphere in the melting step, or controlling the water content or oxygen content in the atmosphere in the forming step. Also, the manufacturing method where a specific salt is contained in the molten salt used for chemical strengthening of the glass substrate is described later in Embodiment 2 of Manufacturing Method of the Present Invention.

### Modification Example

Next, modification examples of the antifouling layer-attached glass substrate in the present invention are described. In the following, as modification examples, an antireflection layer and an antiglare treatment are described, but the antifouling layer-attached glass substrate in the present invention is not limited thereto, and a layer having other functions may be formed on the first main surface 101a of the glass substrate, or the first main surface 101a of the glass substrate may itself be subjected to other treatments.

### (Antireflection Layer)

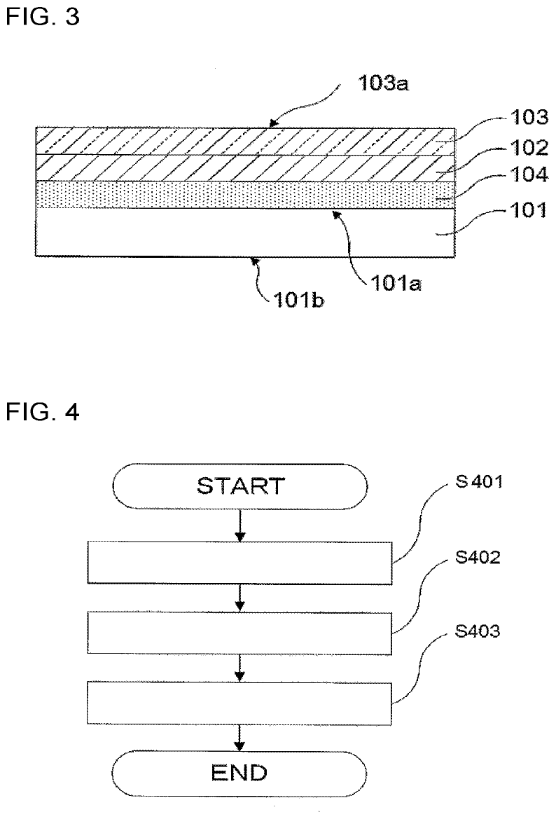

As illustrated in FIG. 3, the antifouling layer-attached glass substrate 100 may have an antireflection layer 104 between the glass substrate 101 and the adhesive layer 102. The antireflection layer 104 may be caused to function as an adhesive layer 102 by decreasing the packing density of the outermost layer or a part of the outermost layer. The antireflection layer 104 is formed, for example, by alternately stacking a high-refractive-index layer and a low-refractive index layer and is a layer formed so as to suppress reflection by external light and enhance the display quality of a displayed image.

The configuration of the antireflection layer 104 is not particularly limited as long as it is a configuration capable of reducing the reflection of light to a predetermined range. For example, the antireflection layer is formed by alternately stacking a high-refractive-index layer in which the refractive index for light having a wavelength of 550 nm is more than 1.6 and a low-refractive-index layer in which the refractive index for light having a wavelength of 550 nm is 1.6 or less.

The antireflection layer 104 may contain one high-refractive-index layer and one low-refractive index layer and preferably contains two or more layers for each refractive-index layer. The antireflection layer contains preferably from 2 to 15 layers, more preferably from 4 to 13 layers, still more preferably from 4 to 10 layers, for each refractive index layer. This number of layers provides good antireflection properties.

The materials constituting the high-refractive-index layer and the low-refractive-index layer are not particularly limited and can be arbitrarily selected in consideration of the antireflectivity level or productivity required. As the material constituting the high-refractive-index, for example, one or more selected from niobium oxide (Nb₂O₅), titanium oxide (TiO₂), zirconium oxide (ZrO₂), tantalum oxide (Ta₂O₅), aluminum oxide (Al₂O₃) and silicon nitride (SiN) may be used. As the material constituting the low-refractive-index layer, one or more selected from silicon oxide (particularly, silicon dioxide SiO₂), a material containing a mixed oxide of Si and Sn, a material containing a mixed oxide of Si and Zr, and a material containing a mixed oxide of Si and Al may be used.

The thickness of the antireflection layer 104 is preferably 150 nm or more, and within this range, the reflection of external light can be effectively reduced. The thickness is more preferably 250 nm or more, still more preferably 350 nm or more. On the other hand, the thickness of the antireflection layer 104 is preferably 1,500 nm or less for ensuring steel wool rubbing resistance of the film and is more preferably 1,000 nm or less, still more preferably 800 nm or less.

### (Antiglare Treatment)

The first main surface 101a of the glass substrate 101 may have a concave-convex shape so as to impart an antiglare property. In the first main surface 101a subjected to an antiglare treatment, the root mean square roughness (RMS) is preferably from 10 nm to 1,500 nm, more preferably from 15 nm to 1,000 nm, still more preferably from 10 nm to 500 nm, yet still more preferably from 10 nm to 200 nm. When RMS is in the range above, the haze value of the first main surface 101a having a concave-convex shape can be adjusted to 3 to 30%, as a result, an excellent antiglare property can be imparted to the antifouling layer-attached glass substrate 100 obtained.

Here, the root mean square roughness (RMS) can be measured in conformity with the method specified in JTS B 0601: (2001). Also, the haze value is a value measured in accordance with the provision of JIS K 7136.

When the first main surface 101a having a concave-convex shape is observed from above, circular holes are observed. The size of the circular hole observed in this way (a diameter in terms of a true circle) is preferably from 5 μm to 50 μm. Within this range, it is possible to achieve both anti-sparkle property and antiglare property of the antifouling layer-attached glass substrate 100.

### Embodiment 1 of Manufacturing Method of the Present Invention

Embodiment 1 in the manufacturing method of the present invention is described below. FIG. 4 illustrates a flow in Embodiment 1 of the manufacturing method.

As illustrated in FIG. 4, the first manufacturing method of an antifouling layer-attached glass substrate includes:

(step S401) a step of preparing a glass substrate having a pair of main surfaces facing each other (glass substrate preparing step),

(step S402) a step of forming an adhesive layer on a main surface of the glass substrate (adhesive layer-forming step), and

(step S403) a step of forming an antifouling layer on the adhesive layer (antifouling layer-forming step).

In the following, each step is described in detail using FIG. 1 and FIG. 4.

### (Step S401)

First, a glass substrate 101 having a first main surface 101a and a second main surface 101b facing each other is prepared. The surface of the glass substrate 101 may arbitrarily be subjected to treatments such as polishing, cleaning and chemical strengthening.

### (Chemical Strengthening Treatment)

The glass substrate 101 can be chemically strengthened by immersing it in a molten salt to apply an ion-exchange treatment to the surfaces of first main surface 101a and second main surface 101b. In the ion-exchange treatment, metal ions having a small ionic radius (typically, Na ion or Li ion) present around the main surface of the glass substrate 101 are replaced by ions having a larger ionic radius (typically, Na ion or K ion for Li ion, and K ion for Na ion). The molten salt is not particularly limited, but, for example, a molten salt containing K ion is selected.

As for the temperature of the molten salt, a temperature not more than the glass transition temperature is selected. Although it may vary depending on the compositions of the glass and molten salt, specifically, a temperature of 350° C. or more and 500° C. or less is selected.

The immersion time is not particularly limited but, usually, is 10 minutes or more and 24 hours or less.

When such a chemical strengthening treatment is applied, the surface hardness of the glass substrate 101 can be enhanced and at the time of application to a cover glass, etc., breakage from impact can be advantageously prevented.

### (Alkali Treatment)

Organic substances attached to the first main surface 101a and second main surface 101b of the glass substrate can be removed by immersing the glass substrate 101 in an alkali solution.

### (Plasma Cleaning)

Organic substances attached to the first main surface 101a can be removed by irradiating the first main surface 101a of the glass substrate with plasma under the atmosphere. Consequently, the adhesiveness to a layer formed on the first main surface 101a is increased, and a flat layer can be formed. In addition, irradiation with plasma brings about modification by OH group, etc. on the surface of the main surface 101a, and this facilitates adsorption of water, so that an effect of increasing the H₂O amount of the entire antifouling layer-attached glass substrate 100 can be expected.

### (Step S402)

Next, an adhesive layer 102 is formed on the first main surface 101a of the glass substrate 101. The method for forming the adhesive layer 102 is not particularly limited, but the adhesive layer can be formed, for example, by a chemical vapor deposition (CVD) method or a physical vapor deposition (PVD) method. The physical vapor deposition method includes a vacuum deposition method and a sputtering method, and the adhesive layer 102 is preferably formed by a vacuum deposition method. The formation by a vacuum deposition method facilitates increasing the H₂O concentration in the adhesive layer 102.

The vacuum deposition method includes, for example, a resistance heating method, an electron beam heating method, a high-frequency induction heating method, a reactive deposition method, a molecular beam epitaxy method, a hot wall deposition method, an ion plating method, a cluster ion beam method, etc. In view of simplicity and low cost, an electron beam heating method is preferably used.

In the vacuum deposition method by ion beam heating, the vacuum deposition apparatus has, in a vacuum chamber, a deposition source and a glass substrate facing the deposition source, and a sample is heated by an electron beam in the deposition source. The sample evaporated by heating is evolved from the deposition source and stacked on the first main surface 101a of the glass substrate to form a film.

The glass substrate 101 may be placed such that the normal line of the first main surface 101a of the glass substrate is parallel to a reference line connecting the center of the first main surface 101a and the center of the deposition source. By such placement, the adhesive layer 102 can be formed flatly on the first main surface 101a of the glass substrate. On the other hand, the glass substrate 101 may also be placed such that the normal line of the first main surface 101a of the glass substrate is inclined to make a predetermined angle with respect to the reference line connecting the center of the main surface 101a and the center of the deposition source, and the inclination angle may be appropriately changed during vapor deposition. This makes it possible to realize a structure having many voids in the adhesive layer 102.

The pressure in the chamber at the time of vacuum deposition is preferably 5×10⁻³ Pa or less. When the pressure in the chamber is in this range, the vacuum deposition can be conducted with no problem. On the other hand, the pressure in the chamber at the time of vacuum deposition is preferably 1×10⁻³ Pa or more, because the deposition rate of the adhesive layer 102 stabilizes.

The gas introduced into the chamber during deposition includes, for example, argon and oxygen. When oxygen is used, the oxygen deficiency of the adhesive layer 102 can advantageously be prevented. The oxygen gas flow rate is preferably 10 sccm or less so as to maintain the adhesion between the adhesive layer 102 and the glass substrate 101.

The sample for vacuum deposition is preferably silicon dioxide. The sample is put in a heating vessel, heated under low vacuum to cause evaporation, and deposited on the first main surface 101a of the glass substrate placed to face the heating vessel.

The deposition rate is preferably 5.0 Å/s or less, because a low density layer is easily formed in the adhesive layer and the H₂O content is likely to be increased. The deposition rate is more preferably 4.0 Å/s or less, still more preferably 2.5 Å/s or less, and on the other hand, the deposition rate is preferably 0.5 Å/s or more, more preferably 1.0 Å/s or more, because the deposition rate stabilizes.

The adhesive layer is preferably vapor-deposited to a thickness of 20 nm or more, more preferably 30 nm or more, still more preferably 50 nm or more. When the thickness of the adhesive layer is in the range above, this is advantageous in that the inside of the adhesive layer is readily separated into two layers having different densities, facilitating the formation of a low density layer in a part of the adhesive layer, and the H₂O content is likely to be increased. The adhesive layer is preferably vapor-deposited to a thickness of 100 nm or less, more preferably 80 nm or less. Deposition to such a thickness is preferred so as to prevent the mechanical rubbing durability of the film from reducing due to an excessive decrease in the packing density of the film.

### (Step S403)

Next, an antifouling layer 103 is formed on the adhesive layer 102.

The method for forming the antifouling layer on the adhesive layer 102 is not particularly limited and includes a wet method such as spin coating method, dip coating method, casting method, slit coating method and spray coating method, and a dry method represented by a vacuum deposition method. In order to form an antifouling layer having high adhesiveness and high abrasion resistance, the antifouling layer is preferably formed by a vacuum deposition method. The vacuum deposition method includes, for example, a resistance heating method, an electron beam heating method, a high-frequency induction heating method, a reactive deposition method, a molecular beam epitaxy method, a hot wall deposition method, an ion plating method, a cluster ion beam method, etc. In view of simplicity of the apparatus and low cost, a resistance heating method is preferred.

The pressure in the chamber at the time of vacuum deposition is preferably 5×10-3 Pa or less. When the pressure in the chamber is in this range, the vacuum deposition can be conducted with no problem. On the other hand, the pressure in the chamber at the time of vacuum deposition is preferably 1×10⁻⁴ Pa or more, because the deposition rate of the antifouling layer can be maintained at not less than a giving rate.

The deposition power is preferably 200 kA/m² or more in terms of current density, because adsorption of water to the antifouling layer can be prevented and the deposition can be stably effected. It is known that if water adsorbs before the antifouling layer is formed on the adhesive layer 102, the antifouling agent is dimerized and does not exhibit sufficient abrasion durability. The deposition power is more preferably 300 kA/m² or more, still more preferably 350 kA/m² or more. On the other hand, the deposition power is preferably 1,000 kA/m² or less, because components of the steel wool or crucible impregnated with raw materials of the antifouling layer can be prevented from evaporation.

The deposition sample is preferably kept in a form of a pellet-like copper container being impregnated with a fluorine-containing organic compound. The impregnation operation is preferably performed in a nitrogen atmosphere. By performing the operation in this way, the number of layers on which the fluorine-containing organic compound is vapor-deposited as single molecules or atoms can be increased, and the abrasion resistance of the antifouling layer 103 is enhanced.

### Embodiment 2 of Manufacturing Method of the Present Invention

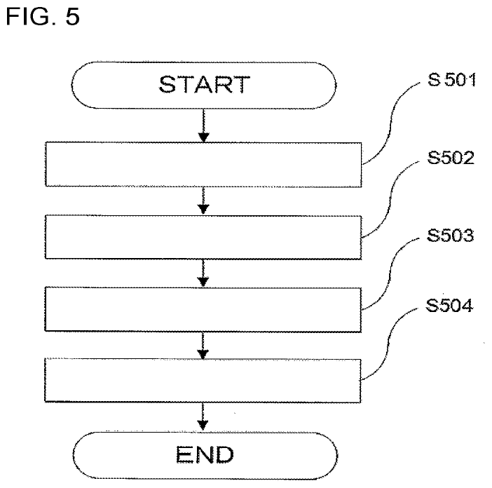

Embodiment 2 in the manufacturing method of the present invention is described below. FIG. 5 illustrates a flow in Embodiment 2 of the manufacturing method.

As illustrated in FIG. 5, the second manufacturing method of an antifouling layer-attached glass substrate includes:

(step S501) a step of preparing a glass substrate having a pair of main surfaces facing each other (glass substrate preparing step),

(step S502) a step of chemically strengthening the main surfaces of the glass substrate by immersing them in a molten salt mainly containing K ion and containing 10 ppm or more of Li ion or 100 ppm or more of NO²⁻ ion or containing both Li ion and NO²⁻ ion, with Li being 10 ppm or more or NO²⁻ being 100 ppm or more (chemical strengthening step),

(step S503) a step of acid-treating the main surfaces of the glass substrate (acid treatment step), and

(step S504) a step of forming an antifouling layer on the glass substrate (antifouling layer-forming step).

In the following, each step is described in detail using FIG. 2 and FIG. 5.

### (Step S501)

First, a glass substrate 101 having a first main surface 101a and a second main surface 101b facing each other is prepared.

### (Step S502)

Next, the glass substrate 101 is chemically strengthened by immersing it in a molten salt mainly containing K ion to apply an ion-exchange treatment to the surfaces of first main surface 101a and second main surface 101b. The molten salt mainly containing K ion is characterized by containing, in weight percentage, 10 ppm or more of Li ion or 100 ppm or more of NO²⁻ ion or containing both Li ion and NO²⁻ ion, with Li ion being 10 ppm or more or NO²⁻ ion being 100 ppm or more. In the case where the molten salt contains both Li ion and NO²⁻ ion, as long as the Li ion concentration is 10 ppm or more, the NO²⁻ ion may be 100 ppm or less, and as long as NO²⁻ ion is 100 ppm or more, the Li ion may be 10 ppm or less.

The Li ion concentration in the molten salt is 10 ppm or more, preferably 50 ppm or more, more preferably 100 ppm or more. The NO²⁻ ion concentration is 100 ppm or more, preferably 150 ppm or more, more preferably 200 ppm or more. It is considered that when the molten salt contains Li or NO²⁻ ion, the glass surface layer reacts with an alkali at a high temperature during strengthening, causing a change in the structure, and the effect of the acid treatment is thereby increased.

On the other hand, in order to maintain good chemical strengthening characteristics, the Li ion concentration is preferably 6,000 ppm or less, more preferably 5,500 ppm or less, still more preferably 5,000 ppm or less. The NO²⁻ ion concentration is preferably 10,000 ppm or less, more preferably 8,000 ppm or less, still more preferably 6,000 ppm or less.

The Li ion concentration in the molten salt can be measured by an atomic absorption spectrophotometer, and the NO²⁻ ion concentration can be measured by a naphthyl-ethylenediamine colorimetric method.

The pH of the molten salt is preferably 7 or more, more preferably 8.5 or more, still more preferably 9 or more, yet still more preferably 9.5 or more, even yet still more preferably 9.7 or more. The H₂O absorbance of the antifouling layer-attached glass substrate 100 can be increased by increasing the pH of the molten salt. On the other hand, the pH of the molten salt is preferably 14 or less, more preferably 13 or less, still more preferably 12 or less, yet still more preferably 11 or less. The pH of the molten salt is adjusted, for example, by controlling the temperature, dew point, etc. of the molten salt. It is considered that when the molten salt is adjusted to a strong alkali, part of SiO₂ constituting a main component of the glass is eluted, for example, according to the following reaction example to increase the irregularities in the glass surface and resultantly, the amount of H₂O or —OH adsorbed increases.

SiO₂+2NaOH→Na₂SiO₃+H₂O Reaction example)

As for the temperature of the molten salt, a temperature not more than the glass transition temperature is selected. Although it may vary depending on the compositions of the glass and molten salt, specifically, a temperature of 350° C. or more and 500° C. or less is selected.

The immersion time is not particularly limited but, usually, is 10 minutes or more and 24 hours or less.

### (Step S503)

Next, the glass substrate 101 is immersed in an acid to acid-treat the surfaces of first main surface 101a and second main surface 101b of the glass substrate. The acid treatment of the glass is performed by immersing a chemically strengthened glass in an acidic solution. In addition, a cleaning effect and an acid treatment effect can also be obtained at the same time by using an acid in the cleaning step.

The acid used is not particularly limited but examples thereof include hydrochloric acid, nitric acid, sulfuric acid, phosphoric acid, acetic acid, oxalic acid, carbonic acid, citric acid, etc. Preferably, nitric acid is used. One of these acids may be used alone, or a plurality thereof may be used in combination. In addition, ultrasonic waves or a chelating agent may also be used so as to increase the effect of the acid treatment.

The solution used is not particularly limited as long as it is acidic. The pH may be less than 7, and in order to increase the effect of the acid treatment, the solution preferably has a pH of 6 or less, more preferably a pH of 5 or less, and most preferably a pH of 4.5 or less. Considering, e.g., corrosion of a container, the pH is preferably 0.5 or more.

The temperature when performing the acid treatment is not particularly limited and is preferably 100° C. or less, though it may vary depending on the type or concentration of the acid used or the time. The time for which the acid treatment is performed is not particularly limited but is preferably from 10 seconds to 2 hours. In view of productivity, the time is preferably 1 hour or less, more preferably 40 minutes or less, and most preferably 20 minutes or less. In order to stably obtain the effect of the acid treatment, the time is preferably 10 seconds or more, more preferably 30 seconds or more, and most preferably 1 minute or more.

A chelating agent is preferably added to the acid. Examples of the chelating agent include a citric acid, EDTA (ethylenediaminetetraacetic acid), NTA (nitrilotriacetic acid), CyDTA (trans-1,2-cyclohexanediaminetetraacetic acid), DTPA (diethylenetriaminepentaacetic acid), and GEDTA (glycoletherdiaminetetraacetic acid), and a citric acid or a metal citrate salt is preferably used. When a chelating agent is added, the glass surface is slightly etched in the process of the acid treatment, and the H₂O amount or —OH amount can be increased.

By performing the acid treatment in this way, the H₂O content in the antifouling layer-attached glass substrate can be increased, and the H₂O absorbance can be increased to 0.010 or more, so that the abrasion resistance of the antifouling layer can be improved.

### Modification Example

Modification examples of the manufacturing method in the present invention are described below. In the following, as modification examples, an antireflection layer-forming step and an antiglare treatment step are described, but the manufacturing method in the present invention is not limited thereto, and a layer having another function may be formed on the first main surface 101a of the glass substrate, or another treatment may be applied to the first main surface 101a itself of the glass substrate.

### (Antireflection Layer-Forming Step)

As illustrated in FIG. 3, the antifouling layer-attached glass substrate 100 may have an antireflection layer 104 between the glass substrate 101 and the adhesive layer 102. The step of forming the antireflection layer 104 is conducted between step S401 and step S402, for example, in the manufacturing flow of FIG. 4. At this time, step S402 does not have to be conducted.

The method for forming the antireflection layer 104 is not particularly limited, but the antireflection layer can be formed, for example, by a chemical vapor deposition (CVD) method or a physical vapor deposition (PVD) method. The physical vapor deposition method includes a vacuum deposition method and a sputtering method.

### (Antiglare Treatment Step)

The first main surface 101a of the glass substrate 101 may have a concave-convex shape so as to impart an antiglare property. The antiglare treatment is not particularly limited and is applied by a chemical method or a physical method to the first main surface 101a of the glass substrate 101. The antiglare treatment by a chemical method includes, specifically, a method of applying a frost treatment. The frost treatment is performed, for example, by immersing the glass substrate 101 as a treatment object in a mixed solution of hydrogen fluoride and ammonium fluoride. The antiglare treatment by a physical method is performed, for example, by a so-called sandblast treatment of blowing a crystalline silicon dioxide powder, a silicon carbide powder, etc. to the surface of the glass substrate 101 with the aid of pressurized air, or a method of water-wetting a brush having attached thereto a crystalline silicon dioxide powder, a silicon carbide powder, etc., and polishing the glass substrate 101 surface by using the brush. Above all, the frost treatment that is a chemical surface treatment can preferably be utilized, because microcracks can hardly be generated on the treatment object surface and a reduction in the strength of the glass substrate 101 is less likely to occur.

Also, in place of the antiglare treatment, an antiglare layer may be formed on the first main surface 101a of the glass substrate 101. The antiglare layer is formed by applying a coating solution containing fine particles of a resin, a metal, etc. according to a wet coating method (e.g., a spray coating method, an electrostatic coating method, a spin coating method, a dip coating method, a die coating method, a curtain coating method, a screen coating method, an ink jetting method, a flow coating method, a gravure coating method, a bar coating method, a flexo coating method, a slit coating method, a roll coating method), etc.

### (Measurement—Test Methods)

The evaluation methods of the antifouling layer-attached glass substrate 100 in the present invention are described blow.

### (Measurement of Absorbance)

In a method of measuring the absorbance inside of the antifouling layer-attached glass substrate by means of a Fourier transform infrared spectrometer (hereinafter, FTIR), the surface on the side where the antifouling layer is formed is measured according to an ATR method (Attenuated Total Reflection), and when the absorbance value at 3,955 cm⁻¹ is set to 0.10, a value (H₂O absorbance) obtained by subtracting, as a base, the absorbance value at 3,955 cm⁻¹ from the peak value of observed absorbance peaks present around 3,400 cm⁻¹, and a value (OH absorbance) obtained by subtracting, as a base, the absorbance value at 3,955 cm⁻¹ from the peak value of observed absorbance peaks present around 3,600 cm⁻¹, are used.

### (Measurement of Water Contact Angle)

As the method for evaluating the antifouling property of the antifouling layer, a water contact angle is measured. A larger water contact angle indicates a more excellent antifouling property. A water droplet of about 1 μL of pure water is dropped and landed on the antifouling layer surface of the antifouling layer-attached glass substrate, and the contact angle of water is measured using a contact angle meter.

### (Measurement of Electric Charge Amount)

The triboelectric charge amount is determined according to Method D (Frictional Electrification Attenuation Measurement Method) described in JIS L1094:2014.

### (Eraser Friction Abrasion Test)

Using a plane abrasion tester, an antifouling layer surface is abraded 7,500 times with an eraser having a diameter of 6 mm under the conditions of a load of 1 kgf, a stroke width of 40 mm, a speed of 40 rpm, 25° C., and 50% RH. After that, the water contact angle on the antifouling layer surface is measured.

### (Steel Wool Abrasion Test)

Using a plane abrasion tester, an antifouling layer surface is abraded 7,500 times with a #0000 steel wool attached to a 1 cm²-indenter under conditions of a load of 1 kgf, a stroke width of 20 mm, a speed of 80 rpm, 25° C., and 50% RH. After that, the water contact angle on the antifouling layer surface is measured.

### EXAMPLES

(Manufacturing Example of Antifouling Layer-Attached Glass Substrate (with Adhesive Layer))

Manufacturing Examples of the antifouling layer-attached glass substrate of the present invention are described below. In Manufacturing Examples here, according to Embodiment 1 of the antifouling layer-attached glass substrate, an adhesive layer was formed between the glass substrate and the antifouling layer. The adhesive layer was formed on the first main surface of the glass substrate. Conditions and evaluation results in each Example are shown together in Table 1 below.

Here, Exs. 1 to 10 are Examples of the invention, and Exs. 11 to 15 are Comparative Examples.

### Ex. 1

As the glass substrate, a glass having, as represented by mass percentage based on oxides, the following composition (Composition Example 1) was prepared.

### Composition Example 1

| | |
|---|---|
| SiO₂ | 69.6% |
| Al₂O₃ | 12.7% |
| MgO | 4.7% |
| ZrO₂ | 2.0% |
| Li₂O | 4.0% |
| Na₂O | 5.4% |
| K₂O | 1.6% |

The glass substrate was cut into a dimension of 10 cm×10 cm, and the first main surface of the glass substrate was then polished.

The glass substrate was immersed in a 100 wt % sodium nitrate solution at a temperature of 410° C. for 4 hours to effect primary strengthening of the surface and then immersed in a mixed solution composed of 99 wt % of potassium nitrate and 1 wt % of sodium nitrate at a temperature of 440° C. for 1 hour to effect secondary strengthening of the surface. After chemical strengthening, the glass substrate was cleaned by immersing it in pure water and an alkaline detergent. Thereafter, the first main surface of the glass substrate was irradiated with plasma to perform plasma cleaning.

Next, an adhesive layer was formed on the first main surface of the glass substrate. Silicon dioxide (manufactured by MERCK, SiO₂ deposition source, granules of 1 to 2.5 mm) was used as the material of the adhesive layer and deposited according to a vacuum deposition method by resistance heating. The pressure in the vacuum chamber during deposition was set to 3.0×10⁻³ Pa, and the film was formed at a deposition power of 0.85 kW and a deposition rate of 1.0 Å/s to impart a thickness of 30 nm of the adhesive layer.

Subsequently, an antifouling layer was formed on the first main surface of the adhesive layer. A fluorine-containing organic compound (manufactured by Daikin, UD-509) was used as the material of the antifouling layer and film-deposited according to a vacuum deposition method by resistance heating. The sample was used in a supported state by immersing an SW-encapsulated pellet-like copper container in a sample solution for 30 minutes under a nitrogen atmosphere in the night of the previous day and then subjecting it to vacuuming. The pressure in the vacuum chamber during deposition was set to 3.0×10⁻³ Pa, and the sample was vapor-deposited at a deposition power of 318.5 kA/m² for 300 sec. The thickness of the antifouling layer was 15 nm.

Exs. 2 to 15 were the same as Ex. 1 except for the adhesive layer forming conditions.

### Ex. 2

In Ex. 2, the film was formed at a deposition rate of 2.5 Å/s to impart a thickness of 30 nm of the adhesive layer.

### Ex. 3

In Ex. 3, the film was formed at a deposition rate of 5.0 Å/s to impart a thickness of 30 nm of the adhesive layer.

### Ex. 4

In Ex. 4, the film was formed at a deposition rate of 1.0 Å/s to impart a thickness of 50 nm of the adhesive layer.

### Ex. 5

In Ex. 5, the film was formed at a deposition rate of 2.5 Å/s to impart a thickness of 50 nm of the adhesive layer.

### Ex. 6

In Ex. 6, the film was formed at a deposition rate of 5.0 Å/s to impart a thickness of 50 nm of the adhesive layer.

### Ex. 7

In Ex. 7, the film was formed at a deposition rate of 1.0 Å/s to impart a thickness of 100 nm of the adhesive layer.

### Ex. 8

In Ex. 8, the film was formed at a deposition rate of 2.5 Å/s to impart a thickness of 100 nm of the adhesive layer.

### Ex. 9

In Ex. 9, the film was formed at a deposition rate of 5.0 Å/s to impart a thickness of 100 nm of the adhesive layer.

### Ex. 10

In Ex. 10, the film was formed at a deposition rate of 2.5 Å/s to impart a thickness of 20 nm of the adhesive layer.

### Ex. 11

In Ex. 11, the film was formed at a deposition rate of 2.5 Å/s to impart a thickness of 10 nm of the adhesive layer.

### Ex. 12

In Ex. 12, a precursor obtained by the sol-gel method was applied by spin coating to the first main surface of the glass substrate and heat-treated to thereby form a SiO₂ adhesive layer on the first main surface of the glass substrate.

### Ex. 13

In Ex. 13, the adhesive layer was formed by a sputtering method. Polycrystalline Si (manufactured by Chemiston, purity: 5N) was used as the sputtering target. The pressure in the chamber during deposition was set to 2.6×10-3 Pa, and an Ar gas and an O₂ gas were introduced at a flow rate of 15 sccm and 60 sccm, respectively. The film was formed at a deposition power of 80 W for a deposition time of 300 sec to impart a thickness of 10 nm of the adhesive layer.

### Ex. 14

In Ex. 14, the adhesive layer was formed by a sputtering method under the same conditions as in Ex. 13. In Ex. 14, the film was formed for a deposition time of 900 sec to impart a thickness of 30 nm of the adhesive layer.

### Ex. 15

In Ex. 15, the adhesive layer was formed by a sputtering method under the same conditions as in Ex. 13. In Ex. 15, the film was formed for a deposition time of 1,500 sec to impart a thickness of 50 nm of the adhesive layer.

### (Evaluation Methods)

The antifouling layer-attached glass substrates obtained above in Examples and Comparative Examples were evaluated by the following methods.

### (Measurement of Absorbance)

Using FTTR (Nicolet 6700, manufactured by Thermo Fisher SCIENTIFIC K.K.), the measurement was performed by a contact method called an ATR method (MicroATR, manufactured Czitek). The absorbance was calculated by subtracting, as a base, the absorbance at a wavelength of 3,955 cm⁻¹ from the absorbance peak attributable to H₂O and present around a wavelength of 3,400 cm⁻¹.

(Measurement of Water Contact Angle)

As the method for evaluating the antifouling property of the antifouling layer, a water contact angle was measured. A water droplet of about 1 μL of pure water was dropped and landed on the antifouling layer surface of the antifouling layer-attached glass substrate 100, and the contact angle of water was measured using a contact angle meter.

### (Measurement of Electric Charge Amount)

The triboelectric charge amount was determined according to Method D (Frictional Electrification Attenuation Measurement Method) described in JIS L1094:2014.

### (Eraser Friction Abrasion Test)

Using a plane abrasion tester (triple-barrel) (manufactured by Daiei Kagaku Seiki MFG. Co., Ltd., device name: PA-300A), an antifouling layer surface was abraded 7,500 times with an eraser having a diameter of 6 mm (manufactured by WOOJIN Inc., PINKPENCIL) under the conditions of a load of 1 kgf, a stroke width of 40 mm, a speed of 40 rpm, 25° C., and 50% RH. After that, the water contact angle on the antifouling layer surface was measured.

### (Steel Wool Abrasion Test)

Using a plane abrasion tester (triple-barrel) (manufactured by Daiei Kagaku Seiki MFG. Co., Ltd., device name: PA-300A), an antifouling layer surface was abraded 7,500 times with a #0000 steel wool attached to a 1 cm²-indenter under conditions of a load of 1 kgf, a stroke width of 20 mm, a speed of 80 rpm, 25° C., and 50% RH. After that, the water contact angle on the antifouling layer surface was measured.

Implementation conditions and evaluation results of Exs. 1 to 15 are shown in Table 1 below. In Exs. 1 to 10 where the H₂O absorbance is 0.010 or more, the water contact angle is 90° or more after the steel wool abrasion test as well as after the eraser friction abrasion test, and it is understood that the abrasion resistance is excellent.

TABLE 1

| | | | Ex. 1 | Ex. 2 | Ex. 3 | Ex. 4 | Ex. 5 |
|---|---|---|---|---|---|---|---|
| Adhesive layer | Vapor | Deposition pressure | 3.0 | 3.0 | 3.0 | 3.0 | 3.0 |
| | deposition | (×10⁻³ Pa) | | | | | |
| | conditions | Power (kW) | 0.85 | 0.85 | 0.85 | 0.85 | 0.85 |
| | | Deposition rate (Å/s) | 1.0 | 2.5 | 5.0 | 1.0 | 2.5 |
| | Two layer separation | | separated | separated | separated | separated | separated |
| | Thickness of silica layer (nm) | | 30 | 30 | 30 | 50 | 50 |
| IR Measurement | 3400 cm⁻¹ H₂O | | 0.014 | 0.014 | 0.014 | 0.018 | 0.018 |
| results | 3600 cm⁻¹ —OH | | 0.0080 | 0.0080 | 0.0080 | 0.011 | 0.011 |
| Durability test | Initial water contact angle (°) | | 115 | 115 | 114 | 114 | 115 |
| results | Water contact angle after | | 102 | 103 | 101 | 103 | 102 |
| | steel wool abrasion test (°) | | | | | | |
| | Water contact angle after | | 110 | 100 | 107 | 107 | 107 |
| | eraser abrasion test (°) | | | | | | |
| Electric charge | Initial electric charge amount (kw) | | 0.00 | 0.00 | 0.00 | 0.00 | 0.00 |
| amount | Electric charge amount after | | 0.00 | 0.00 | 0.00 | 0.00 | 0.00 |
| measurement | steel wool abrasion test (kw) | | | | | | |
| results | Electric charge amount after | | −0.77 | −0.99 | −0.94 | −0.57 | −0.43 |
| | eraser abrasion test (kw) | | | | | | |
| | | | Ex. 6 | Ex. 7 | Ex. 8 | Ex. 9 | Ex. 10 |
| Adhesive layer | Vapor | Deposition pressure | 3.0 | 3.0 | 3.0 | 3.0 | 3.0 |
| | deposition | (×10⁻³ Pa) | | | | | |
| | conditions | Power (kW) | 0.85 | 0.85 | 0.85 | 0.85 | 0.85 |
| | | Deposition rate (Å/s) | 5.0 | 1.0 | 2.5 | 5.0 | 2.5 |
| | Two layer separation | | separated | separated | separated | separated | separated |
| | Thickness of silica layer (nm) | | 50 | 100 | 100 | 100 | 20 |
| IR Measurement | 3400 cm⁻¹ H₂O | | 0.018 | 0.028 | 0.028 | 0.028 | 0.011 |
| results | 3600 cm⁻¹ —OH | | 0.011 | 0.017 | 0.017 | 0.017 | 0.0070 |
| Durability test | Initial water contact angle (°) | | 115 | 114 | 113 | 113 | 115 |
| results | Water contact angle after | | 103 | 101 | 102 | 103 | 103 |
| | steel wool abrasion test (°) | | | | | | |
| | Water contact angle after | | 104 | 105 | 108 | 101 | 90 |
| | eraser abrasion test (°) | | | | | | |
| Electric charge | Initial electric charge amount (kw) | | 0.00 | 0.00 | 0.00 | 0.00 | 0.00 |
| amount | Electric charge amount after | | 0.00 | 0.00 | 0.00 | 0.00 | 0.00 |
| measurement | steel wool abrasion test (kw) | | | | | | |
| results | Electric charge amount after | | −0.97 | −0.34 | −0.57 | −0.68 | −0.75 |
| | eraser abrasion test (kw) | | | | | | |
| | | | Ex. 11 | Ex. 12 | Ex. 13 | Ex. 14 | Ex. 15 |
| Adhesive layer | Vapor | Deposition pressure | 3.0 | spin | sputtering | sputtering | sputtering |
| | deposition | (×10⁻³ Pa) | | coating | | | |
| | conditions | Power (kW) | 0.85 | | | | |
| | | Deposition rate (Å/s) | 2.5 | | | | |

| | | | | | | |
|---|---|---|---|---|---|---|
| | Two layer separation | separated | none | none | none | none |
| | Thickness of silica layer (nm) | 10 | 0 | 10 | 30 | 50 |
| IR Measurement | 3400 cm⁻¹ H₂O | 0.0085 | 0.0010 | 0.0020 | 0.0020 | 0.0020 |
| results | 3600 cm⁻¹ —OH | 0.0055 | 0.0010 | 0.0015 | 0.0015 | 0.0015 |
| Durability test | Initial water contact angle (°) | 114 | 116 | 113 | 114 | 115 |
| results | Water contact angle after | 100 | 43 | 83 | 65 | 46 |
| | steel wool abrasion test (°) | | | | | |
| | Water contact angle after | 81 | 52 | 44 | 60 | 70 |
| | eraser abrasion test (°) | | | | | |
| Electric charge | Initial electric charge amount (kw) | 0.00 | 0.00 | 0.00 | 0.00 | 0.00 |
| amount | Electric charge amount after | 0.00 | 0.00 | 0.00 | 0.00 | 0.00 |
| measurement | steel wool abrasion test (kw) | | | | | |
| results | Electric charge amount after | −0.63 | −0.80 | −0.81 | −1.34 | −0.83 |
| | eraser abrasion test (kw) | | | | | |

(Manufacturing Example of Antifouling Layer-Attached Glass Substrate (without Adhesive Layer))

Manufacturing Examples in the case of not forming an adhesive layer are described below. In the case of not forming an adhesive layer, antifouling layer-attached glass substrates were manufactured according to the manufacturing method described in Embodiment 2 of Manufacturing Method. Conditions and evaluation results in each Example are shown together in Table 2 below.

Here, Exs. 16 to 18 are Examples of the invention, and Exs. 19 to 21 are Comparative Examples.

### Ex. 16

As the glass substrate, a glass having, as represented by mass percentage based on oxides, the following composition (Composition Example 4) was prepared.

### Composition Example 4

| | |
|---|---|
| SiO₂ | 63.5% |
| Al₂O₃ | 18.0% |
| MgO | 2.0% |
| ZrO₂ | 2.5% |
| Y₂O₃ | 1.5% |
| Li₂O | 4.5% |
| Na₂O | 5.5% |
| K₂O | 2.0% |

The glass substrate was cut into a dimension of 10 cm×10 cm, and the first main surface of the glass substrate was then polished. The plate thickness of the glass substrate was 0.55 mm.

Next, the glass substrate was immersed in a sodium nitrate molten salt at a temperature of 410° C. for 4 hours to effect primary strengthening of the surface.

Then, the glass substrate was immersed in a molten salt composed of 99 wt % of potassium nitrate and 1 wt % of sodium nitrate at a temperature of 440° C. for 1 hour to effect secondary strengthening of the surface. Here, the molten salt contained 2,000 ppm of Li ion and 100 ppm of NO²⁻ ion. Also, at this time, the pH of the molten salt was 9.7, and the pH of the molten salt was adjusted by adding 1.15 wt % of sodium metasilicate to the molten salt. The glass substrate after chemical strengthening was ultrasonically cleaned with H₂O.

After the chemical strengthening, the glass substrate was subjected to an acid treatment by immersing it in a nitric acid solution at a temperature of 40° C. and a concentration of 0.1 mol % for 2 minutes. As a chelating agent, potassium citrate was added to the nitric acid solution. The glass substrate after acid treatment was cleaned with an alkaline solution.

Subsequently, an antifouling layer was formed on the first main surface of the glass substrate. A fluorine-containing organic compound (manufactured by Daikin, UD-509) was used as the material of the antifouling layer and film-deposited according to a vacuum deposition method by resistance heating. The sample was used by impregnating it into a pellet-like copper container. The pressure in the vacuum chamber during deposition was set to 5.0×10⁻³ Pa, and the sample was vapor-deposited at a deposition power of 328.5 kA/m² for 300 sec. The thickness of the antifouling layer was 15 nm.

### Ex. 17, Ex. 18

In Ex. 17, the pH of the potassium nitrate molten salt in the secondary strengthening step was 9.5, and in Ex. 18, the pH of the potassium nitrate molten salt in the secondary strengthening step was 7.0. Also, in the acid treatment step, a chelating agent was not added to the nitrate salt. As for other conditions, the antifouling layer-attached glass substrates were manufactured under the same conditions as in Ex. 16.

### Ex. 19

In Ex. 19, a glass substrate having the composition of Composition Example 1 was used and cut into a dimension of 10 cm×10 cm, and the first main surface of the glass substrate was then polished. The plate thickness of the glass substrate was 0.55 mm. In the chemical strengthening step, the glass substrate was immersed in a sodium nitrate molten at a temperature of 450° C. for 1.5 hours to effect primary strengthening of the surface and subsequently immersed in a potassium nitrate molten salt containing 2,000 ppm of Li ion and 100 ppm of NO²⁻ ion at a temperature of 425° C. for 1.5 hour to effect secondary strengthening of the surface. The glass substrate after chemical strengthening was ultrasonically cleaned with H₂O. An acid treatment was not performed, and an alkali treatment was performed before the formation of the antifouling layer. The antifouling layer forming conditions were the same as in Ex. 16.

### Ex. 20

In Ex. 20, an antifouling layer-attached glass substrate was manufactured under the same conditions as in Ex. 16 except that an acid treatment was not performed.

### Ex. 21, Ex. 22

In Ex. 21 and Ex. 22, the glass substrate was immersed in a potassium nitrate molten salt at a temperature of 440° C. for 1 hour in the secondary strengthening step. Here, the molten salt did not contain Li ion and NO²⁻ ion, and the pH of the molten salt was 7.0. Also, in the acid treatment step, the temperature of the nitric acid was set to 60° C. in Ex. 21 and set to 40° C. in Ex. 22. In Ex. 21 and Ex. 22, a chelating agent was not added to the nitric acid. As for other conditions, the antifouling layer-attached glass substrates were manufactured under the same conditions as in Ex. 16.

Implementation conditions and evaluation results of Exs. 16 to 22 are shown in Table 2 below. Here, the evaluation methods are the same as those in Manufacturing Example of Antifouling Layer-Attached Glass Substrate (with adhesive layer). In Exs. 16 to 18 where a chemical strengthening was performed using a potassium nitrate molten salt containing 2,000 ppm of Li ion and 100 ppm of NO²⁻ ion, an antifouling layer-attached glass substrate having a H₂O absorbance of 0.010 or more could be manufactured, and the water contact angle after the steel wool abrasion test as well as after the eraser abrasion test could be kept at 900 or more. Particularly, in the case where a chelating agent is added in the acid treatment, the H₂O absorbance was highest.

TABLE 2

| | | | Ex. 19 | Ex. 20 | Ex. 16 | Ex. 17 | Ex. 18 | Ex. 21 | Ex. 22 |
|---|---|---|---|---|---|---|---|---|---|
| Glass substrate composition | | | Composition | Composition Example 4 | | | | | |
| | | | Example 1 | | | | | | |
| Surface | Chemical | Molten salt | Na₂O (primary strengthening) | | | | | | |
| treatment | strengthening | configuration | K₂O (secondary strengthening) | | | | | | |
| conditions | conditions | Li Content | 2000 | 2000 | 2000 | 2000 | 2000 | 0 | 0 |
| | | (ppm) | | | | | | | |
| | | NO²⁻ Content | 100 | 100 | 100 | 100 | 100 | 0 | 0 |
| | | Treatment | 450° C. | 410° C. (primary strengthening) | | | | | |
| | | temperature | (primary | 440° C. (secondary strengthening) | | | | | |
| | | (° C.) | strengthening) | | | | | | |
| | | | 425° C. | | | | | | |
| | | | (secondary | | | | | | |
| | | | strengthening) | | | | | | |
| | | Treatment | 1.5 hr | 4 hr (primary strengthening) | | | | | |
| | | time | (primary | 1 hr (secondary strengthening) | | | | | |
| | | (hour) | strengthening) | | | | | | |
| | | | 1.5 hr | | | | | | |
| | | | (secondary | | | | | | |
| | | | strengthening) | | | | | | |
| | | Molten salt pH | — | — | 9.7 | 9.5 | 7 | 7 | 7 |
| | Acid | Type of acid | none | none | HNO₃ | | | | |
| | treatment | pH | | | 1 | | | | |
| | conditions | Molar | | | 0.1 | | | | |
| | | concentration | | | | | | | |
| | | [M] | | | | | | | |
| | | Chelating agent | | | potassium | none | none | none | none |
| | | | | | citrate | | | | |
| | | Treatment time | | | 2 | | | | |
| | | (min) | | | | | | | |
| | | Treatment | | | 40 | 40 | 40 | 60 | 40 |
| | | temperature | | | | | | | |
| | | (° C.) | | | | | | | |

| | | | | | | | | |
|---|---|---|---|---|---|---|---|---|
| IR | 3400 cm⁻¹ H₂O | 0.0071 | 0.0043 | 0.0187 | 0.0155 | 0.0125 | 0.0097 | 0.0095 |
| Measurement | 3600 cm⁻¹ OH | 0.0054 | 0.0031 | 0.0097 | 0.0085 | 0.0073 | 0.0057 | 0.0058 |
| results | | | | | | | | |
| Durability | Initial water contact angle (°) | 113 | 114 | 114 | 114 | 115 | 116 | 115 |
| test results | Water contact angle (°) after | 104 | 102 | 107 | 106 | 110 | 106 | 102 |
| | steel wool abrasion test, | | | | | | | |
| | 7500 abrasions | | | | | | | |
| | Water contact angle (°) after | 66 | 95 | 113 | 115 | 113 | 69 | 61 |
| | eraser abrasion test, | | | | | | | |
| | 7500 abrasions | | | | | | | |
| | Water contact angle (°) after | 59 | 51 | 107 | 113 | 108 | — | — |
| | eraser abrasion test, | | | | | | | |
| | 15000 abrasions | | | | | | | |
| Electric | Initial electric charge | 0.00 | 0.00 | 0.00 | 0.00 | 0.00 | 0.00 | 0.00 |
| charge | amount (kV) | | | | | | | |
| amount | Electric charge amount | −0.734 | −0.947 | 0.035 | 0.04 | −0.003 | −0.500 | −0.861 |
| | after 1000 times of eraser | | | | | | | |
| | abrasion test (kw) | | | | | | | |

### (Composition Example of Glass Substrate)

Next, examples of the glass composition suitably used for the glass substrate in the present invention are shown in Table 3. The composition is represented by mass percentage based on oxides

TABLE 3

| | Composition Example | | | | | | | | | | | | | | | |
|---|---|---|---|---|---|---|---|---|---|---|---|---|---|---|---|---|
| (wt %) | 1 | 2 | 3 | 4 | 5 | 6 | 7 | 8 | 9 | 10 | 11 | 12 | 13 | 14 | 15 | 16 |
| SiO₂ | 69.6 | 69 | 68 | 63.5 | 61 | 62.5 | 56.5 | 59.5 | 57.5 | 57 | 57 | 62.9 | 56.3 | 56 | 55.7 | 55 |
| Al₂O₃ | 12.7 | 20.5 | 21 | 18 | 19 | 18 | 25 | 19 | 24 | 24 | 24.5 | 18 | 25.5 | 23 | 24.5 | 23.5 |
| B₂O₃ | 0 | 1.5 | 2 | 0 | 0.5 | 0 | 0.5 | 0.5 | 7.5 | 0 | 7 | 0 | 0.2 | 2.5 | 0 | 2 |
| P₂O₅ | 0 | 0 | 0 | 0 | 0 | 0 | 5.5 | 0 | 0 | 5 | 0 | 0 | 6 | 5 | 5.3 | 5.5 |
| MgO | 4.7 | 1 | 2 | 2 | 0 | 2 | 0 | 0 | 0.5 | 0 | 1 | 2 | 0 | 0 | 0 | 0 |
| CaO | 0 | 0 | 0 | 0.5 | 0.5 | 0 | 0 | 1 | 1.5 | 0 | 1 | 0.2 | 0 | 0 | 0 | 0 |
| SrO | 0 | 0 | 0 | 0 | 0 | 0 | 0 | 0.5 | 2 | 0 | 1.5 | 0 | 0 | 0 | 0 | 0 |
| ZnO | 0 | 1.5 | 1 | 0 | 1 | 0 | 0 | 0.5 | 0 | 1 | 0 | 0 | 0 | 1.5 | 1.5 | 1 |
| ZrO₂ | 2 | 0 | 0 | 2.5 | 3 | 2.5 | 0 | 3 | 0 | 0 | 0.5 | 2.5 | 0 | 0 | 0 | 0 |
| Y₂O₃ | 0 | 0 | 0 | 1.5 | 0 | 2 | 0 | 0 | 0 | 0 | 0 | 1.8 | 0 | 0 | 0 | 0 |
| Li₂O | 4 | 3.5 | 4 | 4.5 | 5 | 5 | 3 | 5.5 | 3 | 3 | 3.5 | 4.9 | 3.5 | 2 | 2.5 | 2 |
| Na₂O | 5.4 | 2.5 | 2 | 5.5 | 10 | 5.5 | 8.5 | 10 | 4 | 10 | 3.5 | 5.5 | 8 | 10 | 10.5 | 10.5 |
| K₂O | 1.6 | 0.5 | 0 | 2 | 0 | 2.5 | 1 | 0.5 | 0 | 0 | 0.5 | 2.2 | 0.5 | 0 | 0 | 0.5 |

While the invention has been described in detail and with reference to specific embodiments thereof, it will be apparent to one skilled in the art that various changes and modifications can be made therein without departing from the spirit and scope of the invention. This application is based on Japanese Patent Application (Patent Application No. 2019-030975) filed on Feb. 22, 2019, the contents of which are incorporated herein by way of reference.

### REFERENCE SIGNS LIST

100 Antifouling layer-attached glass substrate
101 Glass substrate
101a First main surface of glass substrate
101b Second main surface of glass substrate
102 Adhesive layer
102a First surface of adhesive layer
102b Second surface of adhesive layer
103 Antifouling layer
103a First surface of antifouling layer 103
103b Second surface of antifouling layer 103
104 Antireflection layer

1. An antifouling layer-attached glass substrate comprising:
a glass substrate comprising a pair of main surfaces facing each other; and
an antifouling layer formed on or above at least one main surface of the glass substrate,
wherein at the time of measuring an absorbance inside the antifouling layer-attached glass substrate by a Fourier transform infrared spectrophotometer according to ATR method (Attenuated Total Reflection) from a surface on a side where the antifouling layer is formed, in the case where an absorbance value at 3,955 cm⁻¹ is set to 0.10, a value (H₂O absorbance) obtained by subtracting, as a base, the absorbance value at 3,955 cm⁻¹ from a peak value of an absorbance peak which appears around 3,400 cm⁻¹ is 0.010 or more.

2. The antifouling layer-attached glass substrate according to claim 1,
wherein at the time of measuring the absorbance inside the antifouling layer-attached glass substrate by a Fourier transform infrared spectrophotometer according to ATR method (Attenuated Total Reflection) from the surface on the side where the antifouling layer is formed, in the case where the absorbance value at 3,955 cm⁻¹ is set to 0.10, a value (Si—OH absorbance) obtained by subtracting, as the base, the absorbance value at 3,955 cm⁻¹ from a peak value of an absorbance peak which appears around 3,600 cm⁻¹ is 0.0070 or more.

3. The antifouling layer-attached glass substrate according to claim 1,
wherein the glass substrate is a chemically strengthened glass.

4. The antifouling layer-attached glass substrate according to claim 1,
wherein the glass substrate has a composition comprising, as represented by mass percentage based on oxides,
from 55 to 80% of SiO₂,
from 10 to 28% of Al₂O₃,
from 0 to 10% of B₂O₃,
from 2 to 10% of Li₂O,
from 0.5 to 11% of Na₂O,
from 0 to 10% of K₂O,
from 0 to 10% of MgO+CaO+SrO+BaO, and
from 0 to 5% of ZrO₂+TiO₂.

5. The antifouling layer-attached glass substrate according to claim 1, comprising an adhesive layer formed between the glass substrate and the antifouling layer.

6. The antifouling layer-attached glass substrate according to claim 5,
wherein the adhesive layer is a silicon dioxide film.

7. The antifouling layer-attached glass substrate according to claim 5,
wherein the adhesive layer has a thickness of 20 nm or more and 100 nm or less.

8. The antifouling layer-attached glass substrate according to claim 5,
wherein the adhesive layer comprises two layers having different densities.

9. A method for manufacturing an antifouling layer-attached glass substrate, comprising:
preparing a glass substrate having a pair of main surfaces facing each other;
immersing the glass substrate in a molten salt containing K ion to perform chemical strengthening;
acid-treating the main surfaces of the glass substrate; and
forming an antifouling layer on at least one main surface of the glass substrate,
wherein the molten salt in the chemical strengthening further contains 10 ppm or more of Li ion or 100 ppm or more of NO²⁻ ion, or contains Li ion and NO²⁻ ion, with a Li ion content being 10 ppm or more or a NO²⁻ ion content being 100 ppm or more.

10. The method for manufacturing an antifouling layer-attached glass substrate according to claim 9,
wherein an acid used in the acid treatment has a pH of 4.5 or less.

11. The method for manufacturing an antifouling layer-attached glass substrate according to claim 9,
wherein an acid used in the acid treatment is nitric acid.

12. The method for manufacturing an antifouling layer-attached glass substrate according to claim 9,
wherein a chelating agent is added in the acid treatment.

13. The method for manufacturing an antifouling layer-attached glass substrate according to claim 9,
wherein the molten salt has a pH of 7 or more.
